(19) United States
(12) Patent Application Publication
(10) Pub. No.: US 2002/0178148 A1
(43) Pub. Date: Nov. 28, 2002

(54) Source-level threads

(76) Inventors: Jonathan Sobel, Cary, NC (US); Jonathan Rossie, Cary, NC (US); John Michael Lake, Cary, NC (US)

Correspondence Address: Thomas E. Anderson, Hunton & Williams, Suite 1200, 1900 K Street, N.W., Washington, DC, 20006, US

(21) Appl. No.: 09/822,774

(22) Filed: Mar. 30, 2001

(51) Int. Cl. G06F 7/00

(52) U.S. Cl. 707/3

(57) ABSTRACT

A technique for allowing lightweight cooperative multitasking to be used as if it were pre-emptive multitasking, in a fashion that is transparent to the development process. The technique accepts a long-running program which it then transforms into a co-operative multitasking program that yields the processor after a small amount of time has elapsed. This technique imposes a small overhead on the transformed long-running program, but no overhead on the original co-operative multitasking program. This contrasts strongly with the usual case in pre-emptive multitasking, which imposes its overhead on all processes in the system. The transformed long-running program can be throttled either statically or dynamically in response to changing conditions. This technology is designed to be compatible with a variety of approaches to co-operative multitasking asynchronous message-passing systems.

### FIELD OF THE INVENTION

The present invention relates generally to transforming reactive-control programs from preemptive multitasking form to run-to-completion form. More particularly, to a technique for automating the task of breaking down long-running tasks into a plurality of short-running tasks.

### BACKGROUND OF THE INVENTION

High-speed, reactive-control systems, which are at the heart of telecommunications, must often re-implement algorithms and existing processor code that were developed without the necessary properties for this specialized setting. Integrating these rogue elements into a computer system is currently either a performance-degrading change to the system architecture or a time-consuming and error-prone manual effort requiring highly specialized training.

There are two general models of behavior for computer systems in which a single processor is supposed to complete several tasks: run-to-completion and multitasking. In the run-to-completion model, the first task is begun and completely finished, then the second task is begun and completely finished, and so on. Each task runs to completion before the next begins.

Run-to-completion systems are considerably easier to model analytically than multitasking systems. For example, run-to-completion systems enable simple proofs of freedom from deadlock and ability to meet responsiveness requirements.

In the multitasking model, the first task runs for a little while and stops, perhaps unfinished. Then the second task runs for a little while and stops, perhaps also unfinished. And so on, cycling through until the tasks are finished. The processor really works on only one task at a time, but the effect is as if it were making progress on several tasks simultaneously.

The multitasking model can be split further into cooperative multitasking and preemptive multitasking. In cooperative multitasking, each task is responsible for yielding control of the processor to the other tasks after running for a short time. Co-operative multitasking typically operates by requiring the long-running computations to volunteer to be suspended at “good stopping points.”

One basic cooperative multitasking model involves placing processor yields strategically throughout the code. For example, the sumto computation shown in FIG. 1 is a simple example of potentially long-running computation. This is a tight loop (three instructions on an Intel Pentium) and so may be able to meet, for example, a 1 ms bound for n<n₀ for some no. A value of n₀+1 may cause untimely completion of this or a subsequently delayed computation, perhaps leading to localized or total system failure.

Using cooperative multitasking the sumto might be changed as in FIG. 2. The yield is responsible for 1) saving all relevant machine state (stack, registers, etc.); 2) invoking another (at least as high priority) task; and 3) arranging the system so sumto will eventually be re-started. If the yield call is simply a replacement for timer-driven preemption, this is just as expensive as a full preemptive context switch.

In preemptive multitasking, some sort of operating system forcibly takes control away from each task and gives it to another every so often. Pre-emptive multitasking typically operates by suspending the currently running task every few milliseconds, selecting a (perhaps different) task from a ready-to-run queue, setting up its context, setting a hardware interrupt to wake the scheduler at the next preemption interval, and then finally giving the processor to the selected task.

Of these models, run-to-completion is the most efficient. Next is cooperative multitasking which is a considerably lower overhead mechanism (i.e., more efficient) than pre-emptive approaches because it enables a host of optimizations and therefore delivers higher throughput. Preemptive multitasking is the least efficient.

With pre-emptive multitasking some amount of overhead is introduced by switching from one task to another in the middle of the tasks, and this overhead is greatest when the operating system has to make the switch without the consent or assistance of the tasks. The overhead is eliminated by allowing each task to run until it is finished.

The cooperative multitasking model is in-between in the amount of overhead it introduces, but it places the most burden on the programmer to yield control in the “right” places. In the worst case, if the programmer makes a poor choice, the illusion of simultaneous work is broken, and the model degenerates into run-to-completion.

Some cooperative multitasking systems use but a single execution stack. This minimizes the cost of saving the relevant machine state and arranging for the yielding process to be restarted. This focuses the cost of invoking another task on selecting the task (e.g., invoking another (at least as high priority) task). Even so, yields remain fairly disruptive and expensive relative to not yielding, and so yields are often throttled by offering to yield only every nth coherent point (e.g., at tripct=10, as shown in FIG. 3). This can distribute hundreds of constants like tripct (FIG. 3) throughout a system, each of which may require re-tuning for each system update. This, coupled with the increase in code complexity demonstrated by this (FIG. 3) version of sumto, reveals the brittleness and high risk of fault injection virtually guaranteed by cooperative multitasking.

Cooperative multitasking is frequently selected for its ability to deliver high-throughput when the majority of tasks are short-lived. Short-lived tasks may never need to participate in multitasking, giving the majority of the system a run-to-completion flavor.

In addition, cooperative multitasking imposes tasking overhead on only long-running tasks, whereas the pre-emptive model can impose substantial overhead on essentially every task.

Pre-emptive multitasking's overhead stems from two main sources: arbitrary suspension and mutual exclusion. Any process, even a short-running process, may be suspended by the operating system at any time, so guaranteed response time requires a priority system; but preventing starvation requires increasing a process's priority so it eventually spends some time as the highest priority process. Since any process could be suspended at any time, pre-emptive multitasking requires some mechanism to guarantee mutually exclusive access to shared data structures.

In a run-to-completion or cooperative multitasking model, such suspension cannot occur and so no processor cycles need be devoted to coordination around critical sections. Programmers are almost always considerably more comfortable programming to a pre-emptive multitasking model. It is possible to program as if the application were the only process, particularly when it neither accesses nor updates globally shared data. This makes it highly attractive to programmers faced with an inherently long running computation, such as finding the least costly paths through a large network.

Given the strengths and weaknesses of these approaches, a dilemma may arise in a real-time or a “reactive control” system. That is, a system whose primary function is to react to external control signals. Further, suppose that the system must react very, very quickly to repeated signals, such as Internet Protocol (IP) packets. In this case, the overhead introduced by preemptive multitasking is often too great for the system to keep up with its inputs, and the various tasks performed by the system are often too complex for programmers to correctly implement cooperative multitasking. This situation leaves the run-to-completion model as the only alternative.

The run-to-completion model is a satisfactory solution to this problem provided that there is no task that takes too long, where “too long” means that completing the task would cause the system to get behind in its processing of the incoming signals. Unfortunately, in almost all sufficiently complex systems, there are some tasks that take too long.

For example, in a high-speed Internet router, the routing tables must be updated occasionally, and this update process may take several seconds or minutes; the incoming packets, however, expect to be serviced in tiny fractions of a second.

Other existing solutions to this problem also have drawbacks. One existing solution is to force the programmers to divide long-running tasks into smaller sub-tasks, each of which can be completed quickly using a run-to-completion style. This way, no single task can take too long and cause the system to get behind in its processing of incoming signals. In reality, some tasks are too intricately structured for even the best programmers to divide. Either the sub-tasks remain too large and long-running, or the subdivision is done incorrectly and the system fails.

The second solution is to give up on the run-to-completion model and return to preemptive multitasking. In other words, rely on the operating system to divide up the tasks. This is probably the most common solution, since it is much more likely to yield a correctly functioning system. But in a very, very high-speed reactive control system, no task can be allowed to run for more than a fraction of a second before the operating system switches to another task. As the “fraction of a second” (called a timeslice) gets smaller and smaller, the operating system's task-switching overhead starts to outweigh the real progress of the individual tasks. This solution has often been good enough in the past, but we are now starting to see systems in which the timeslice has to be so small that preemptive multitasking introduces as much as 1000% overhead. This is a drawback.

When multitasking is not available from the operating system or when the operating system's version of multitasking is inadequate, it has been shown that the programming language can be modified to provide similar services. Friedman, Haynes, and Wand showed in 1984 how to modify a programming language to support what they called “engines” for this purpose. A drawback of this approach is that it requires changing the programming language.

In view of the foregoing, it would be desirable to provide a technique for transforming reactive-control programs from preemptive multitasking form to run-to-completion form which overcomes the above-described inadequacies and shortcomings. More particularly, it would be desirable to provide a technique for automating the task of breaking down long-running tasks into a plurality of short-running tasks in an efficient and cost effective manner.

### SUMMARY OF THE INVENTION

According to the present invention, a technique for transforming programs having a first multi-tasking property to programs having a second multi-tasking property is provided. In one embodiment, the technique is realized by transforming programs having a first multi-tasking property into a data structure. Then, the technique comprises transforming the data structure to include an explicit multi-tasking transfer of control command. The technique may also comprise optimizing the data structure to reduce an amount of program state (i.e., the current values in machine registers and memory) that is saved at a transfer of control. The technique may also comprise generating programs having a second multi-tasking property using the optimized data structure.

Some programming-language compilers use techniques and program transformations that are similar to these for starting with a high-level language that is very different from C and producing C or machine code. As far as the inventors are aware, no one else has ever modified the techniques to automate the translation of, for example, C/C++ programs designed for a multitasking system into new C/C++ programs designed for a high-performance run-to-completion system. The application of these techniques to languages like C or C++ is believed novel.

The present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is an example of an unbounded computation in accordance with the present invention.

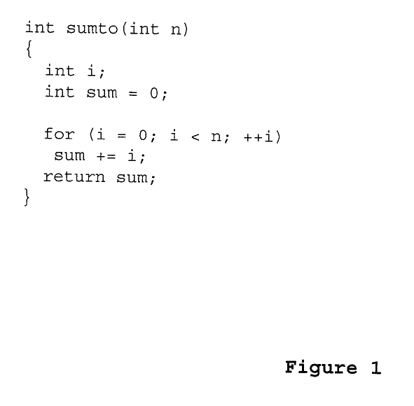

FIG. 2 is an example of an unbounded, but cooperative, computation according to one embodiment of the invention.

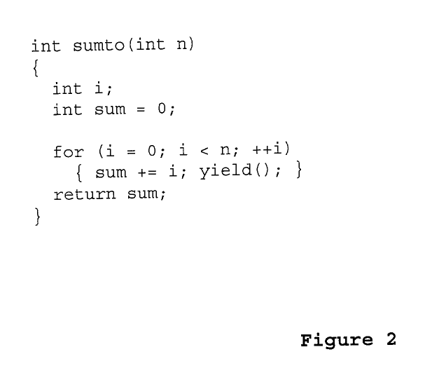

FIG. 3 is an example of an unbounded, cooperative, efficient computation according to one embodiment of the invention.

FIG. 4 is a schematic flow diagram of a transformation according to one embodiment of the invention.

FIG. 5 is a schematic flow diagram of an automatic transformation according to one embodiment of the invention.

FIG. 6 is an example of a transformed computation according to one embodiment of the invention.

FIG. 7 is an example of a translation of a computation according to one embodiment of the invention.

### DETAILED DESCRIPTION OF EXEMPLARY EMBODIMENT(S)

The invention provides a specific technique that takes reactive-control programs written for the preemptive multitasking model and automatically transforms them into new programs in the same programming language that work in the run-to-completion model. In effect, transformation automates the subdivision of long-running tasks into very many very-short-running tasks. Some embodiments of the invention may be viewed as implementing threads (a particular form of multitasking) at the program-source level, instead of at the more traditional operating-system level. Another view is that by extracting the finite-state machines implicit in the programs, the invention allows the programs to suspend after each state transition.

Experimental results indicate that this technique allows the timeslice spent on a single task to be three orders of magnitude (a thousand times) smaller than in preemptive multitasking systems, while simultaneously reducing the 1000% overhead to less than 25%.

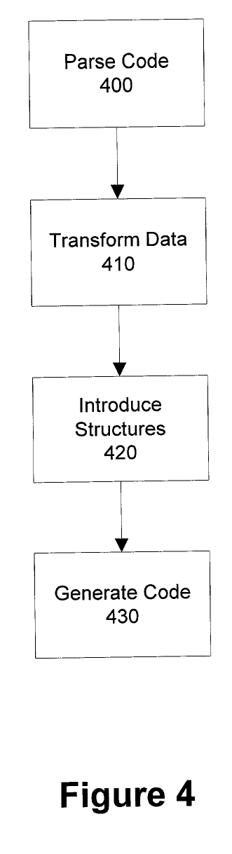

As shown in FIG. 4, the steps one embodiment of the system follows to transform programs into new programs with the desired properties are as follows:

At step 400, parse the source code into an abstract data-structure representation.

At step 410, transform the data structures so that transfers of control (jumps, loops, function calls, etc.) are explicitly described in the data structure, rather than being implicitly described by the language implementation. The new form is similar to “Continuation-Passing Style,” a program form used by researchers in programming languages and some compiler writers.

At step 420, introduce new structures into the now-explicit control points. The new structures represent code that checks a “countdown” to determine whether the program should really continue or whether it should save the relevant portions of its current state and stop, simulating a new “external” signal that says to continue the program later. These structures may cause the program to be similar to “Trampolined Style,” a program form used by some compilers for advanced languages when they are compiling into lower-level languages like C.

At step 430, use the final version of the abstract data-structure representation to automatically generate new source code suitable for compilation using whatever compiler was used for the original code.

This transformation process enables functional properties of the programs, other than those that are specific to whether the program runs all at once or in pieces, to remain unchanged and maintained.

In particular, unless a program depends on taking a certain amount of time to run, embodiments of this transformation will never break a working program.

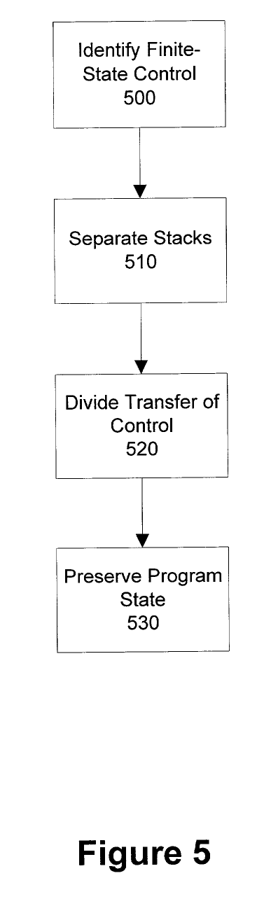

The present invention provides a technology to allow programmers to write “long-running computations” as if they were programming to a pre-emptive multitasking system. These long-running computations can then be transformed algorithmically and automatically to co-exist in a cooperative multitasking environment in a correctness preserving fashion. The transformed programs use as much of the processor as is available, but can (offer to) yield the processor with high frequency and very low overhead. The automated transformation of the invention rests on four key techniques as shown in FIG. 5.

The techniques are: at step 500, automatic identification of the long-running computation's finite-state control; at step 510, separation of the program's control stack from the system stack; at step 520, dividing each transfer of control into where? and when?; and at step 530, preserving the minimum amount of program state required at each yield point.

The transformed program may then be executed step-by-step through a driver loop that repeatedly steps the program through the coherent yield points identified by the transformation. At each step, the driver loop may decide whether the program has consumed its allotment of time or whether time remains. If time remains, the driver loop executes the next step; otherwise, it may suspend the computation and switch to another computation.

The coherent yield points are identified by first parsing the program into an abstract syntax tree (e.g., as at step 400); then converting that abstract syntax tree into a representation of a “continuation-passing style” (CPS), or some similar style that makes the control and data stacks explicit (e.g., as at step 410); then optimizing the CPS, or other, form to minimize the amount of program state that must be saved at each yield point through a combination of live-variable analysis, register allocation, and register assignment; then using the optimized CPS, or other form to generate an equivalent program in the original source language that breaks each transfer of control into two parts, for example, a return of the current continuation to the driver loop followed by an invocation of that continuation. As described above, the driver loop may delay the second step indefinitely by returning to its invoker.

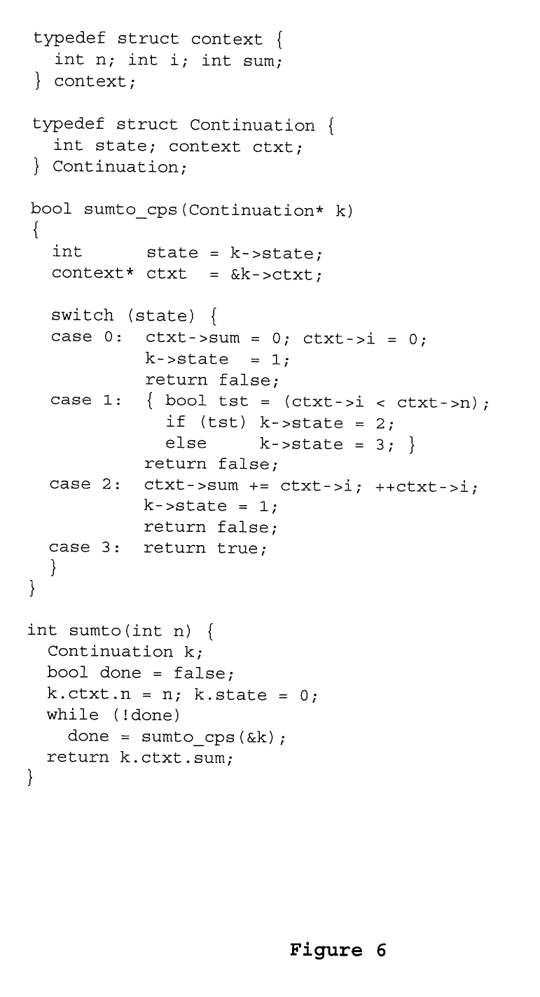

The flavor of one embodiment of this transform is captured in application to sumto as shown in FIG. 6. In some embodiments, the translation splits the sumto computation into two functions. The new sumto is the driver loop, which uses sumto_cps, a CPS-form of the original sumto with explicit stack manipulations. sumto cps returns true if and only if the computation has completed.

The CPS form of a program is equivalent to a conventional flowgraph, augmented to manipulate the control and data stacks explicitly. The flowgraph is the finite-state controller corresponding to each routine, and a “continuation” in the above sense is simply the address of the first instruction in the next basic block to be executed. The control stack is an explicitly manipulated data structure, rather than a structure implicitly managed by the language implementation. In this way, the amount of context that must be specially squirreled away during a program yield is minimized, comprising two machine words: one to identify the finite-state machine state, the other to identify the top of the explicitly manipulated stack. In essence, this transformation gives an explicit source-level representation of distinct computational threads, vastly reducing the overhead associated with typical thread packages.

The source-to-source, semantics-preserving nature of the transformation enables the transformed program to be as portable as the original program, as it introduces no new assumptions about the properties of the processor. Some embodiments of this translation may be specifically designed to be fully compatible with asynchronous messaging systems with first-in-first-out (FIFO) delivery of messages and run-to-completion semantics. To arrange the restarting of the long-running computation with the current continuation, the long-running computation simply sends a message to itself containing the current continuation, which, as described above, is effectively two machine words.

Results well-known within a certain segments of the programming languages community (continuations from denotational semantics and language implementation; flowgraphs with explicit stack manipulation from optimizing compilers) showed the finite-state control could be extracted from general (recursive) programs. Further, from the mid-1980's the Scheme programming language community has been using continuations to simulate multitasking. These techniques are adapted to extract the finite-state machines from programs automatically, render the machine in the source language, and control the timeslice at runtime so it reflects response-time requirements and system load. Thus, a long-running computation can be transformed into a short computation algorithmically. Indeed, if the computation is not completed in a timely fashion, the computation can be halted simply by dropping the continuation, rather than killing an operating-remove space system level thread. The techniques are also applicable to general (possibly blocking) system calls on POSIX-compliant systems.

Table I shows performance results for program run length using the present invention. One benchmark is simply an overhead benchmark: how much more does the computation cost with source-level threading than without? Table I shows a typical realization of the Dijkstra calculation for finding least-cost paths through a directed graph, a long-running computation task common to Internet routing algorithms. The results shown are for runs without optimizing the translation (i.e., without minimizing the amount of program state saved at each yield, but instead saving it all, and using indirect jumps for all jumps instead of direct jumps where possible). A simple throttling mechanism based on “ticks” was used to control the frequency of yields. Each “tick” corresponded to the execution of a single basis block (a sequence of instructions not including a jump or call instruction). By varying the number of ticks, we control the number of basic blocks executed between yields. For example (Table 1), by selecting 35,000 ticks between yields, we caused the program to yield on average every 1.2 ms; this increased the total runtime of the program from 5.30 seconds to 6.84 seconds, an overhead of 29%. This increase was caused by a simplistic rendering of the yield code, which always employed indirect jumps, even when the actual target was known. Since indirect jumps cost approximately 8 times the cost of a direct jump, and the translator can optimize indirect jumps almost everywhere, we estimate the optimized overhead at about 8% for 1.2 ms (35,000 tick) yields.

TABLE 1
SAMPLE OVERHEADS FOR VARIOUS TIMESLICE SIZES

| Ticks between | Average time | | | |
|---|---|---|---|---|
| yields | between yields | | Total time | Overhead |
| ∞ | | | 5.30 s | |
| 35,000 | 1.2 | ms | 6.84 s | 29% |
| 1,000 | 35 | μs | 6.93 s | 31% |
| 50 | 1.75 | μs | 8.41 s | 59% |

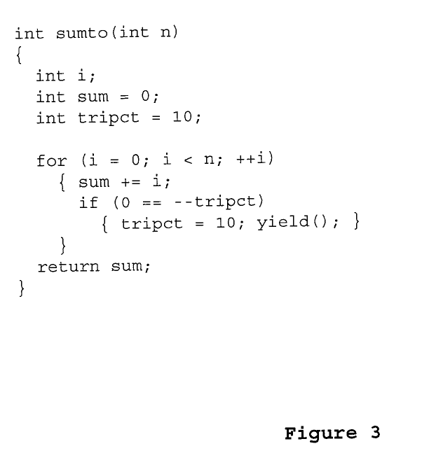

Since this overhead is imposed only on the long-running computation and not on all the natural co-operative multitasking programs, this has the potential for substantially reducing the processing load. These results were generated implementing a C/C++ compiler performing this translation automatically. The translator combines the techniques of FIG. 3 and FIG. 6, generating code that can be dynamically throttled.

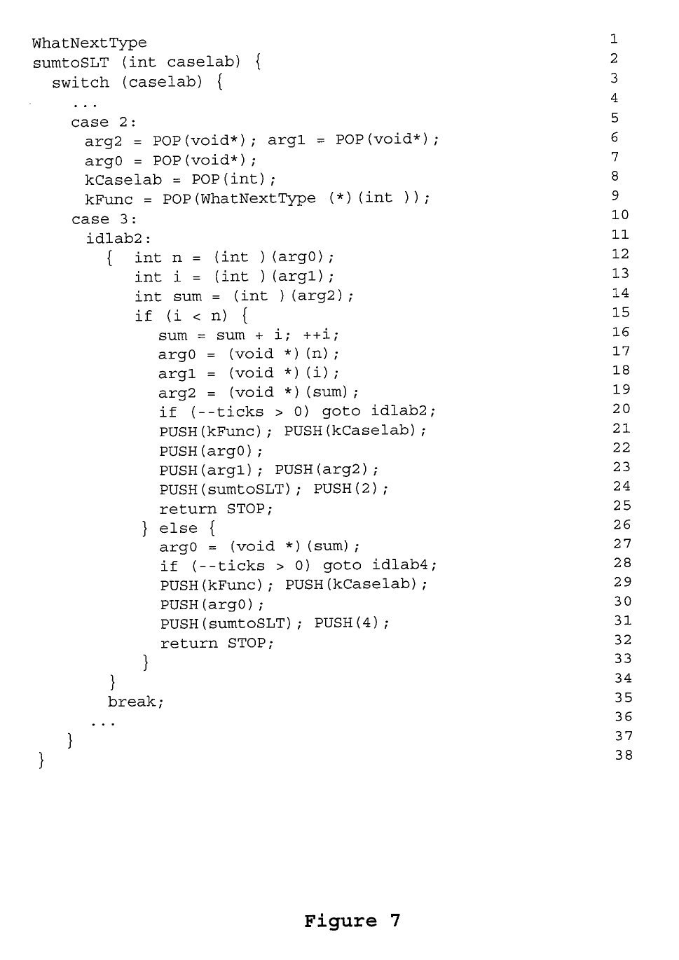

FIG. 7 shows the effect of the combined translation on the body of the for loop in sumto. The generated code still takes the form of a switch on a basic block number with a “yield” at the end, but the yield is conditionalized to avoid the overhead of an additional procedure call and return. Notice lines 10 and 11: line 10 is a switch target, whereas line 11 is a statement label. This allows a direct goto to be used instead of the return-call-switch sequence when a yield is not to be taken, considerably reducing the overhead apparent in the less sophisticated translation in FIG. 6. In the normal case, time will be left on the timer and the goto will be used. When the timer expires, the code saves the live variables and returns to the caller with an indication that it is not yet done. The generated code is structured to allow the C compiler's register allocator to eliminate most of the redundant copies (lines 12-14 and 17-19) simply by allocating (e.g., n and arg0) to the same processor register.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. A method for transforming a program having a first multi-tasking property to a program having a second multi-tasking property, the method comprising:
transforming a first program having a first multi-tasking property into a data structure;
transforming the data structure to include an explicit multi-tasking transfer of control command;
optimizing the data structure to reduce an amount of program state that is saved at a transfer of control; and
generating a second program having a second multi-tasking property using the optimized data structure.

2. The method of claim 1, wherein the data structure further comprises a syntax tree.

3. The method of claim 2, wherein the step of transforming the data structure to include an explicit multi-tasking transfer of control command further comprises:
converting the syntax tree to a continuation-passing style (CPS).

4. The method of claim 1, wherein the first multi-tasking property comprises a property relating to a preemptive multitasking model and the second multi-tasking property comprises a property relating to a run-to-completion model.

5. The method of claim 1, wherein the first program having a first multi-tasking property operates using a first program language and the second program having a second multi-tasking property also operates using the first program language.

6. A system for transforming a program having a first multi-tasking property to a program having a second multi-tasking property, the system comprising:
a data structure transformer for transforming a first program having a first multi-tasking property into a data structure;
a multi-tasking transformer for transforming the data structure to include an explicit multi-tasking transfer of control command;
a program state optimizer for optimizing the data structure to reduce an amount of program state that is saved at a transfer of control; and
a program generator for generating a second program having a second multi-tasking property using the optimized data structure.

7. The system of claim 6, wherein the data structure further comprises a syntax tree.

8. The system of claim 7, wherein the multi-tasking transformer further comprises:
a converter for converting the syntax tree to a continuation-passing style (CPS).

9. The system of claim 6, wherein the first multi-tasking property comprises a property relating to a preemptive multitasking model and the second multi-tasking property comprises a property relating to a run-to-completion model.

10. The system of claim 6, wherein the first program having a first multi-tasking property operates using a first program language and the second program having a second multi-tasking property also operates using the first program language.

11. An article of manufacture for transforming a program having a first multi-tasking property to a program having a second multi-tasking property, the article of manufacture comprising:
at least one processor readable carrier; and
instructions carried on the at least one carrier;
wherein the instructions are configured to be readable from the at least one carrier by at least one processor and thereby cause the at least one processor to operate so as to:
transform a first program having a first multi-tasking property into a data structure;
transform the data structure to include an explicit multi-tasking transfer of control command;
optimize the data structure to reduce an amount of program state that is saved at a transfer of control; and
generate a second program having a second multi-tasking property using the optimized data structure.

12. A processor readable medium for providing instructions to at least one processor for directing the at least one processor to:
transform a first program having a first multi-tasking property into a data structure;
transform the data structure to include an explicit multi-tasking transfer of control command;
optimize the data structure to reduce an amount of program state that is saved at a transfer of control; and
generate a second program having a second multi-tasking property using the optimized data structure.

13. A signal embodied in a carrier wave and representing sequences of instructions which, when executed by at least one processor, cause the at least one processor to transform a program having a first multi-tasking property to a program having a second multi-tasking property by performing the steps of:
transforming a first program having a first multi-tasking property into a data structure;
transforming the data structure to include an explicit multi-tasking transfer of control command;
optimizing the data structure to reduce an amount of program state that is saved at a transfer of control; and
generating a second program having a second multi-tasking property using the optimized data structure.
